(19) United States
(12) Patent Application Publication
(10) Pub. No.: US 2007/0126979 A1
(43) Pub. Date: Jun. 7, 2007

(54) Eyewear

(76) Inventor: Roberto Carlon, Venezia (IT)

Correspondence Address: YOUNG & THOMPSON, 745 SOUTH 23RD STREET, 2ND FLOOR, ARLINGTON, VA, 22202, US

(21) Appl. No.: 11/602,189

(22) Filed: Nov. 21, 2006

(30) Foreign Application Priority Data
Nov. 25, 2005 (IT) BO2005A000711

(51) Int. Cl. G02C 1/08

(52) U.S. Cl. 351/100

(57) ABSTRACT

Eyewear (10) comprises lens means (12, 14) having a peripheral border surface (13, 15) and a peripheral groove (17, 19) made in the peripheral border surface (13, 15) said groove constituting means for connecting frame pieces (16, 18) to the peripheral border of the lens means (12, 14). The frame pieces (16, 18) have a circumferential body (20, 22) and means for connecting the latter to the lens means (16, 18), said connecting means comprising a respective radial protrusion (24) extending from the inside border (20a, 20b) of the frame piece (16).

### FIELD OF THE INVENTION

This invention relates to eyewear.

### BACKGROUND OF THE INVENTION

Current eyewear designs include eyeglasses with annular frame elements fitted round the outer edges of the lenses for decorative purposes.

According to prior art, lenses designed to receive this type of decorative annular element comprise a bevel, or radial protrusion, running circumferentially round the edge of the lens and shaped to fit into a matching groove made in the decorative annular element.

This type of connection between lens and decorative annular element is difficult to form and can only be made by the manufacturer of the eyewear or by skilled personnel.

That means that, when purchasing eyewear, the buyer must choose a pair already fitted with a certain decorative annular element and may not adapt the eyewear to suit personal taste or, once purchased, change the decorative element with another.

Further, the eyewear cannot be used without the decorative element because not only is the protruding bevel extending round the edge of the lens unattractive but can also be dangerous for the wearer since it can cause cuts or scratches.

### SUMMARY OF THE INVENTION

The invention therefore provides eyewear comprising lens means having a peripheral border surface and a peripheral groove made in the peripheral border surface, said groove constituting means for connecting frame pieces to the peripheral border of the lens means.

This provides eyewear which can be fitted with an optional frame piece or decorative element that can be applied or removed without spoiling the overall esthetic appearance of the eyewear.

The invention also provides eyewear, in particular of the rimless type, comprising lens means with a peripheral border surface; comprising frame pieces having a circumferential body and means for connecting the latter to the lens means, said connecting means comprising a respective radial protrusion extending from the inside border of the frame pieces.

This provides eyewear which can be fitted with an optional frame piece or decorative element quickly and easily even by the wearer himself.

The invention also relates to a frame piece and a set of different frame pieces to meet different user needs.

### BRIEF DESCRIPTION OF THE DRAWINGS

These and other technical characteristics of the eyewear according to the invention are clearly described in the claims below and the advantages of the invention are apparent from the detailed description which follows, with reference to the accompanying drawings which illustrate a preferred embodiment of it provided merely by way of example without restricting the scope of the inventive concept, and in which:

FIG. 1 is a perspective view of a preferred embodiment of the eyewear according to the invention;

FIG. 2 is a perspective view of the preferred embodiment of the eyewear according to the invention, without the annular frame piece;

FIG. 3 is a cross section of a lens and respective frame piece in the preferred embodiment of the eyewear according to the invention;

FIG. 4 is a front view of a frame piece according to a first preferred embodiment of the invention;

FIG. 5 is perspective view of a set of frame pieces differing in outward appearance and/or color;

FIG. 6 schematically illustrates the different steps in a method for making the preferred embodiment of the frame piece.

### DESCRIPTION OF THE PREFERRED EMBODIMENT OF THE INVENTION

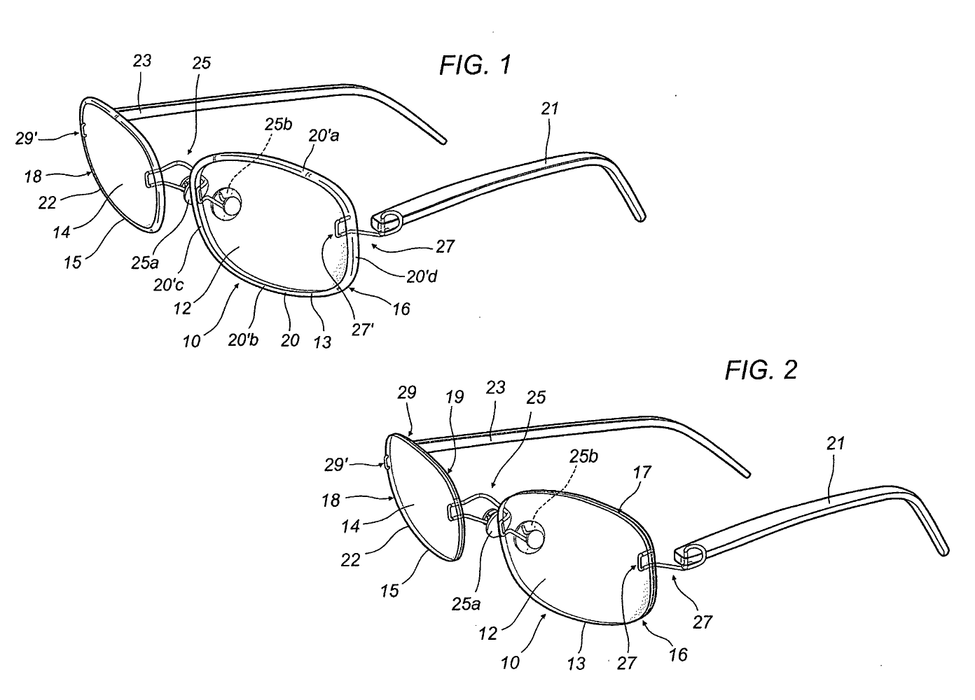

FIGS. 1 and 2 illustrate a preferred embodiment 10 of the eyewear according to the invention, in particular eyewear of the rimless type. In practice, in this eyewear, the lens means do not have mounting rims and each sidepiece is connected directly to the respective lens and converge towards the circumferential bottom surface 17a.

As illustrated, the eyewear 10 comprises lens means, specifically in the form of a first and a second lens 12 and 14, each having a peripheral border surface 13, 15 and means for connection to a respective frame piece, described in more detail below, said frame pieces being connectable to the peripheral border 13, 15 of the respective lens element.

Advantageously, the lens means 12, 14 have a respective peripheral groove 17, 19 which extends into the body of the lens means themselves at the respective border surfaces 13, 15 which constitute means for connecting respective annular frame pieces 16, 18.

As illustrated, each lens 12, 14 has a peripheral border surface 13, 15 and a respective peripheral groove 17, 19 extending into the body of the lens.

In particular, each connecting groove 17, 19 runs along the border all the way around the perimeter of the respective lens 12, 14.

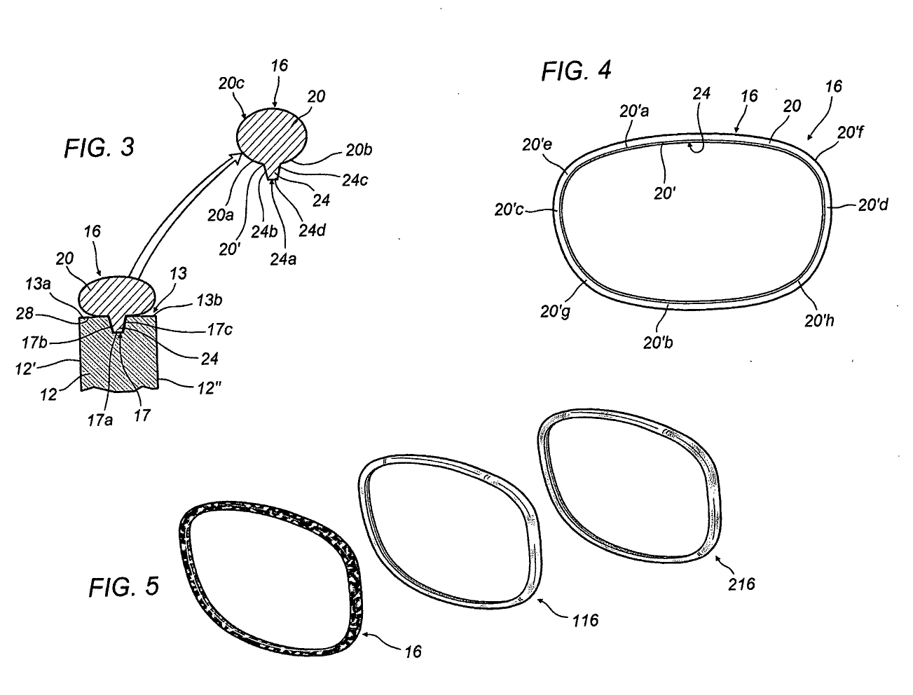

As shown, with reference to FIG. 3, each connecting groove (only the groove 17 in the lens 12 being illustrated in FIG. 3) has a substantially triangular cross section and is made in a substantially central zone of the peripheral border surface 13 of the respective lens.

Looking in more detail, as shown in FIG. 3, which illustrates the first lens 12 of the eyewear according to the invention, each lens comprises a groove 17 which in turn comprises a bottom surface 17a and opposing side surfaces 17b, 17c extending inside the body of the lens, starting from the circumferential border surfaces 13a, 13b of the border 13 of the lens, said circumferential border surfaces, respectively front and rear 13a, 13b, are connected to the front surface 12′ and rear surface 12″ of the lens, respectively.

As shown in FIG. 3, the surfaces 13a, 13b constitute abutment surfaces for respective circumferential inside surfaces of the frame pieces, as will be seen in more detail below.

The eyewear according to the invention also comprises a first and a second sidepiece 21 and 23 which support the lens means 12, 14, and, more specifically, which are directly connected through respective hinges 27, 29, with C-shaped connections 27′, 29′, to the respective sides of the first and second lenses 12, 14.

Further, the first and second lenses 12, 14 are connected, through a respective bridge 25 which is inserted directly into the body of the lens, on the latter's inner side, that is to say, on the side opposite that from which the respective sidepiece extends. Extending from the bridge there are nose pads, labeled 25a, 25b.

Advantageously, the eyewear according to the invention can be worn with frame pieces 16, 18, as shown in FIG. 1, or without these frame pieces, as illustrated in FIG. 2, and in the latter case, without spoiling the esthetic appearance of the eyeglasses or making them less practical for the wearer.

Each frame piece 16, 18 comprises a circumferential body 20, 22 and means for connection to the lens means.

More specifically, the means for connection to the lens means 12, 14 comprise respective protrusions, only the protrusion 24 relating to the frame piece 16 associated with the first lens 12 being illustrated in FIGS. 3 and 4.

As illustrated, this connecting protrusion 24 extends from the inside edge 20a, 20b of the frame piece 16.

As shown in particular in the cross section of FIG. 3, the frame piece 16 connectable to the first lens, in the same way as the frame piece 18 connectable to the second lens 14, has a main body 20 with a generally circular cross section and a circumferential protrusion 24 extending radially from the inner side, defined by the surfaces 20a, 20b, of the frame piece body 20.

The frame piece also has an outer peripheral surface 20c, designed to remain in view when the frame piece is mounted on the lens.

In use, the surfaces 20a and 20b, on each side of the connecting protrusion 24 abut against the corresponding surfaces 13a, 13b on each side of the groove 17, as shown in FIG. 3.

Again with reference to FIG. 3, the connecting protrusion 24 has a radial end or tip 24a formed by a circumferential surface 24d and opposing side surfaces 24b, 24c, giving the perimetric protrusion 24 a generally triangular shape. The side surfaces 24b, 24c diverge in the direction of the main body 20 of the frame piece.

As shown in particular in FIG. 4, the connecting protrusion 24 extends all the way around the inside perimeter of the respective frame piece 20.

Also, as shown in particular in the cross section of FIG. 3, the protrusion 24 extends in a substantially central zone of the peripheral inside surface 20a, 20b of the respective frame piece 16.

As illustrated, each frame piece 16, 18 consists of an annular body whose profile extends circumferentially and corresponds to the outer perimeter of the respective lens 12, 14 it is connected to.

In particular, as illustrated, according to this embodiment, each frame piece 16, 18 has an elongated and substantially quadrangular shape, with an upper portion 20′a, a lower portion 20′b, and opposing side portions 20′c, 20′d, joined by respective arcuate portions 20′e, 20′f, 20′g, 20′h.

As illustrated, the eyewear comprises a first and a second frame piece 16, 18 matching the shape of the lenses which they are connected to.

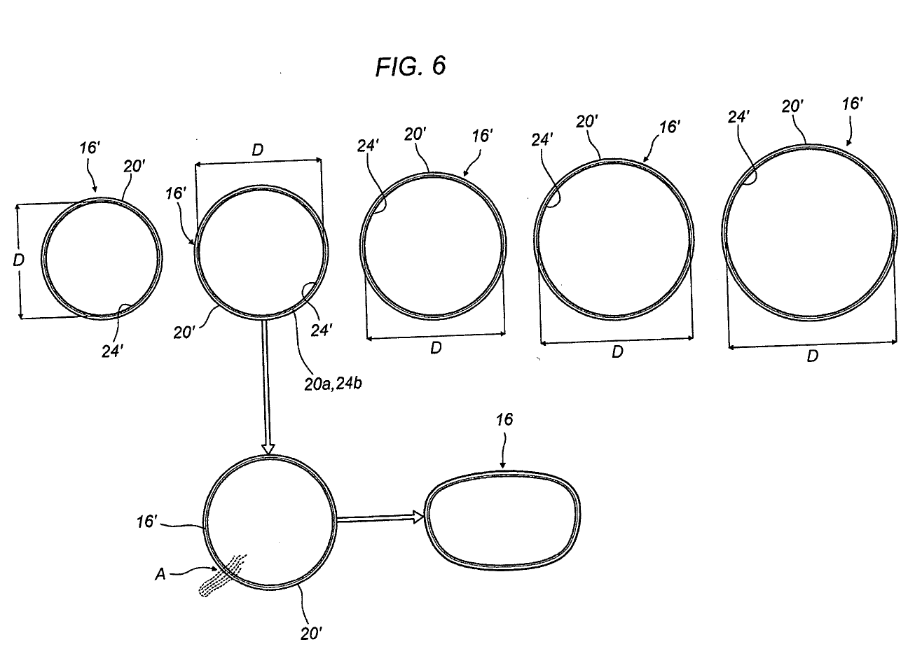

The steps in the advantageous and preferred method for making this frame piece are schematically illustrated in FIG. 6.

Preferably, each frame piece 16, 18 is made of plastic, of suitable color, which can be suitably shaped to adapt it to the shape of the outer profile of a lens and which is, pliable just enough to enable it to be pressed lightly into the lens all the way around.

The annular element 16′ is made preferably by molding the plastic and then suitably shaping it by heating the parts of it to be bent.

As illustrated in FIG. 6, to facilitate the preparation of specific lens frame pieces, a plurality of basic circular elements 16′ are used, being preferably of cellulose acetate, comprising a circular body 20′, from which there extends inwards a protrusion 24′ whose cross section is generally triangular in shape, and having a diameter “D”.

In practice, a plurality of basic circular elements 16′ having different diameters “D”, specifically basic circular elements of diameter between 34 mm and 50 mm, are used and each is appropriately formed into a frame piece whose shape is such as to match the outer profile of the lens it is to be fitted to.

Thus, by choosing a circular element with a suitable diameter “D” it is possible to frame any type of lens.

In practice, the most suitable annular element 16′ is the one whose inside face 20a, 20b, from which the triangular protrusion 24 extends, defines an inside circle that corresponds to the perimeter of the border 13 of the lens.

This annular element 16′ is heated at certain points “A” and suitably formed to make a frame piece 16 whose shape corresponds to the outer profile of the lens border 13.

The formed frame piece is then applied to the lens by moving it close to the front surface 12′ of the lens and pressing it with the fingers in the direction of the back of the lens.

As may be inferred from FIG. 5, upon purchasing a pair of eyeglasses, the buyer might be provided with a set or plurality of frame pieces 20, 116, 216, advantageously enabling him to change the esthetic appearance of the eyewear whenever desired by simply fitting a frame piece of different color or design.

In practice, for each eyewear lens, the buyer might be provided with a set or plurality of frame pieces differing in color or outward appearance.

It will be understood that although the frame piece described has a main body whose cross section is substantially circular, frame pieces with other shapes and with differently shaped connecting protrusions are also imaginable.

It will also be understood that, in the context of this invention, although the term “lens means” denotes the first and the second lens of the eyewear, the term might also include the combination of the lenses with the means by which the lenses are mounted.

The invention described has evident industrial applications and may be subject to modifications and variations without thereby departing from the scope of the inventive concept. Moreover, all the details of the invention may be substituted by technically equivalent elements.

What is claimed is:

1. Eyewear (10) comprising lens means (12, 14) having a peripheral border surface (13, 15); comprising a peripheral groove (17, 19) made in the peripheral border surface (13, 15) of the lens means (12, 14), said groove constituting means for connecting frame pieces (16, 18) to the peripheral border of the lens means.

2. The eyewear according to claim 1, wherein the groove (17, 19) constituting the connecting means extends into the body of the lens means (12, 14).

3. The eyewear according to claim 1, wherein the lens means comprises a first and a second lens (12, 14).

4. The eyewear according to claim 1, wherein the connecting groove (17, 19) runs all the way around the perimeter of the lens means (12, 14).

5. The eyewear according to claim 1, wherein the connecting groove (17, 19) has a substantially triangular cross section.

6. The eyewear according to claim 1, wherein the connecting groove (17, 19) runs along a substantially central portion of the peripheral border surface (13, 15) of the respective lens means (12, 14).

7. The eyewear according to claim 1, wherein the groove has a circumferential bottom surface.

8. The eyewear according to claim 7, wherein the groove has side surfaces converging towards the bottom of it.

9. The eyewear according to claim 1, comprising frame pieces (16, 18) having a circumferential body (20, 22) and means for connecting the latter to the lens means, said connecting means comprising a respective radial protrusion (24) extending from the inside border (20a, 20b) of the frame piece (16).

10. The eyewear according to claim 9, wherein the frame pieces (16, 18) comprises a connecting protrusion (24) running circumferentially all the way around their respective inside perimeters (20a, 20b).

11. The eyewear according to claim 9, wherein the frame pieces (16, 18) consist of respective annular bodies (20, 22) each having a circumferential profile that substantially corresponds to the perimeter of each lens element (12, 14).

12. The eyewear according to claim 9, wherein the radial protrusion (24) has a substantially triangular cross section.

13. The eyewear according to claim 9, wherein the radial protrusion (24) runs all the way around the perimeter of the respective frame piece.

14. The eyewear according to claim 9, wherein the radial protrusion (24) runs along a substantially central portion of the inside peripheral surface (20, 20b) of the respective frame piece (16).

15. The eyewear according to claim 9, wherein the frame pieces (16, 18) are made of plastic.

16. The eyewear according to claim 9, wherein the frame pieces (16, 18) comprises a main body (20, 22) whose cross section is substantially circular in shape.

17. The eyewear according to claim 9, wherein the frame pieces (16, 18) are made of cellulose acetate.

18. The eyewear according to claim 9, wherein the frame pieces (16, 18) are made using circular elements having a diameter between 34 mm and 50 mm.

19. The eyewear according to claim 9, wherein the frame pieces (16, 18) are made in a suitable color.

20. The eyewear according to claim 1, comprising a first and a second sidepiece (21, 23) for supporting the lens means (12, 14).

21. The eyewear according to claim 9, wherein the connecting protrusion has a circumferential end surface.

22. The eyewear according to claim 9, wherein the connecting protrusion has opposing side surfaces that diverge in the direction of the main body.

23. A frame piece applicable to the outer profile of lens means of a respective eyewear and made according to claim 9.

24. A set of frame pieces applicable to the outer profile of lens means of a respective eyewear, wherein each frame piece is made according to claim 9 and wherein the frame pieces in the set differ in color and/or outward appearance.

25. A method for making a frame piece applicable to the outer profile of lens means of respective eyewear, comprising a step of making an annular element (20, 22) with an internal protrusion (24).

26. A method for making a frame piece applicable to the outer profile of lens means of a respective eyewear, wherein a plurality of annular elements with an internal protrusion are made and, of these, the one whose inside diameter corresponds to the outer perimeter of the lens it is to be applied is selected.

27. The method according to claim 25, comprising the step of heating the annular element (20, 22) at appropriate points on the outer profile of the annular element in such a way as to be able to adapt its profile to the profile of the lens (12, 14) it is to be applied to.

28. The method according to claim 25, wherein the annular element is made by molding a suitable material.

29. The method according to claim 28, wherein the material is cellulose acetate.

30. The method according to claim 26, wherein the inside diameter of the circular element is between 34 mm and 50 mm.

31. An element used for making a lens frame piece, comprising a substantially circular main body and having an inside surface from which a circumferential engagement protrusion extends
